(19) United States
(12) Patent Application Publication
(10) Pub. No.: US 2019/0155595 A1
(43) Pub. Date: May 23, 2019

(54) METHOD FOR UPDATING SECURITY ELEMENTS, CORRESPONDING OTA PLATFORM AND SECURITY ELEMENT

(71) Applicant: GEMALTO SA, Meudon (FR)

(72) Inventors: Cyril SOLÉ SALA, Gemenos (FR); Jorge CORTES VARA, Gemenos (FR)

(73) Assignee: GEMALTO SA, Meudon (FR)

(21) Appl. No.: 16/313,600

(22) PCT Filed: Jun. 21, 2017
(86) PCT No.: PCT/EP2017/065300

§ 371 Date: Dec. 27, 2018

(30) Foreign Application Priority Data
Jun. 28, 2016 (EP) 16305780.5

(51) Int. Cl. G06F 8/65; H04W 8/20; H04L 29/08; H04W 12/06; H04W 12/04; H04W 12/00; H04W 76/10; H04W 4/70; H04W 4/80

(52) U.S. Cl. CPC G06F 8/65; H04W 8/205; H04L 67/322; H04W 12/0609; H04W 12/04033; H04W 84/12; H04W 12/004; H04W 76/10; H04W 4/70; H04W 4/80; H04L 67/34; H04W 12/001

(57) ABSTRACT

The invention relates in particular to a method for updating security elements cooperating with telecommunications terminals, the updates being performed by an OTA platform on the basis of queries formulated by the security elements, the security elements transmitting PSK-IDs to the OTA platform, the method comprising transmitting, from the security elements to the OTA platform, identities defining an order of priority of requests for handling the queries of same by the OTA platform.

The present invention relates to the field of telecommunications and more specifically, that of remote administration of security elements, such as UICCs (Universal Integrated Circuit Cards), interacting with terminals, portable terminals for instance, such as telephones, smartphones, PDAs or computers. The security elements may also be in the form of integrated circuits in machines, such as in the field of M2M (Machine to Machine). They are not necessarily physically connected to the terminal and can however communicate with the latter via a short-haul link in which a security element is remote and communicates via a short-haul channel with the terminal (Bluetooth or Wifi for example).

Such administration of security elements is typically performed OTA (Over The Air) in order to update or install data or programs in the security elements. Administration of this kind can use http protocols (HyperText Transfer Protocol) or SMS (Short Message Service).

There are two ways of administering security elements:

the first involves transmitting data or programs from an OTA platform to targeted security elements, for example during update campaigns. This type of administration is known as “push” and is based on transmission in SMS mode. The problem with this method is that it is unsuitable in new-generation networks, such as pure LTE networks that do not support SMS (they are fully http). Furthermore, RAM- or RFM-type administrations by http have been set up to avoid unreliable protocols such as SMS.

The second involves querying the OTA platform, for example, regularly or when an event occurs, to find out if there are any updates available. This query is initiated by the security element and is called “polling” or “pull” (the security element sees whether the OTA platform has anything to transmit to it). The query is performed via the http protocol.

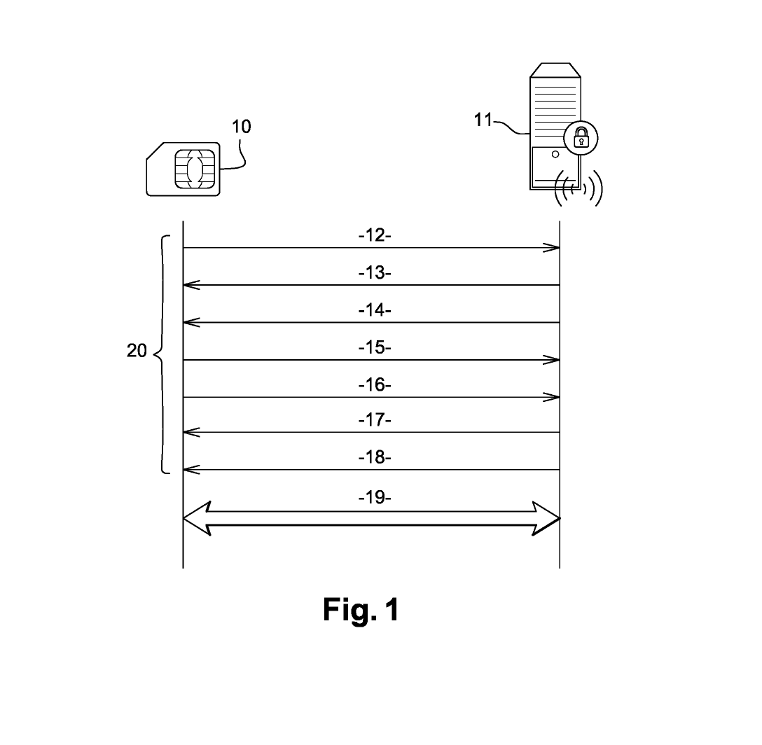

FIG. 1 illustrates a system for administering security elements based on this principle.

In this figure, a security element 10 is administered by an OTA platform 11 or server.

The security element 10 interacts with a telecommunications terminal, not illustrated.

The process begins with a stage 12 involving querying the OTA platform 11, at the initiative of the security element 10, to find out whether the former has data or programs to transmit to the latter. All the exchanges illustrated are carried out according to the SCP 81 protocol.

During a stage 13, the server 11 answers the security element 10 stating that it has received the latter's request and confirms this reception during a stage 14.

During the stage 15, the security element 10 sends a PSK ID to the server 11. A PSK ID refers a pre-established key (PSK) shared between the security element 10 and the server 11, associated with an identity (ID). By means of this PSK key, the server 11 recognises the security element 10.

Advantageously, reference should be made to the IETF recommendation available at the following address: https://tools.ietf.org/html/rfc4279.

During a stage 16, the security element 10 selects a cipher suite, for example an AES 128 or 3DES suite.

The server 11 accepts, during a stage 17, the proposed cipher suite and subsequently, during a stage 18, finalises establishment of the handshake channel with the security element 10.

Stage 19 subsequently involves exchanging data on the secure TLS-PSK channel thus established. In particular, during this stage 19, the security element 10 transmits a URL to the server 11, with this URL corresponding to the reason for its request (simple data update, activation of security element 10 if this is its first use, . . . ).

The problem with this solution lies in the fact that in general, the security element 10 does not wait for an event to occur to query the OTA platform 11. “Polling” is therefore performed regularly, every fifteen days or monthly for example and the majority of the time, the OTA platform 11 does not have anything to transmit to the security element 10 . . . The applicant has noticed for example that in 90% of queries of the OTA platform 11 by the security elements 10 in the field, no updates or programs or data are to be transmitted to the security elements 10. This results in unnecessary wireless traffic and overburdening of the OTA platform (a TLS-PSK link is established between the security element and the OTA platform each time the security element is queried). Stages 12 to 18, usually referenced by 20, are therefore unnecessary most of the time.

Another problem is that the OTA platform 11 is constantly being used for various tasks that do not all have the same degree of urgency. For example, it is more important to initialise a security element 10 (when the subscriber inserts it into a terminal for the first time) so that the subscriber can quickly make calls (download his or her contact directory for example or download a full subscription) rather than update his or her PLMN (Public Land Mobile Network—list of foreign networks to which the security element 10 will preferably connect when roaming).

Consequently, there is no distinction in the processing of requests that are urgent and those that are not. The OTA server 11 may in this case be caused to reject connection requests from security elements 10 that urgently need to be updated if it is overwhelmed by other less urgent requests from other security elements.

In addition, when an internal network of a data centre is involved in updating security elements (e.g. a data centre of a security element manufacturer with whom the mobile operator has located its services), unnecessary strain will be placed on this network too. Furthermore, when this network uses physically decentralised servers, additional communications will be added.

In order to overcome this disadvantage of the second way of operating, two solutions are possible:
Extend the period between two OTA platform queries (“polling”) (an application in the security element is updated to extend this period). The disadvantage is that if updates are available immediately after the last query, the security element will only be updated much later;
Switch to “push” mode. The problems mentioned above are encountered again in this case.

The present invention more particularly aims at overcoming these drawbacks.

More specifically, the invention relates in particular to a method of updating security elements interacting with telecommunications terminals, the updates being carried out by an OTA platform based on requests made by the security elements and the security elements transmitting PSK IDs to the OTA platform, wherein the process involves transmitting identities (IDs) from the security elements to the OTA platform that define an order of priority for requesting that account be taken of their requests by the OTA platform.

In a preferred embodiment, the method involves transmitting the PSK IDs to the OTA platform via a proxy server.

Advantageously, the proxy server filters the requests based on the identities (IDs) before forwarding them to the OTA platform if the identities (IDs) have an order of priority higher than a value stored in the proxy server.

Preferentially, the identities (IDs) can be modified OTA, in order to change the orders of priority as well as add and delete IDs.

The invention also relates to a security element interacting with a telecommunications terminal, wherein the security element is arranged to transmit a PSK ID to a remote platform in order to establish a secure channel between the security element and the remote platform, the identity (ID) defining an order of priority for requesting that account be taken of its request by the remote platform.

In an advantageous embodiment, the remote platform is an OTA platform.

In another embodiment, the remote platform is a proxy placed between the security element and an OTA platform.

The invention also relates to an OTA platform designed to administer security elements interacting with terminals, wherein the security elements transmit update requests to the OTA platform, the OTA platform comprising means of administration of the security elements, the platform comprising means of filtering the requests, the requests comprising PSK IDs, the identities (IDs) of which define an order of priority for requesting that account be taken of their requests by the OTA platform, the means of filtering transmitting to the means of administration of the security elements only those requests, the identities (IDs) of which are below a reference value so that the means of administration can manage the security elements from which they originate.

Other characteristics and advantages of the invention will appear when reading the following description of two preferential embodiments, which are given as a non-limitative illustration and referring to the appended drawings wherein:

FIG. 1 illustrates the state of the art;

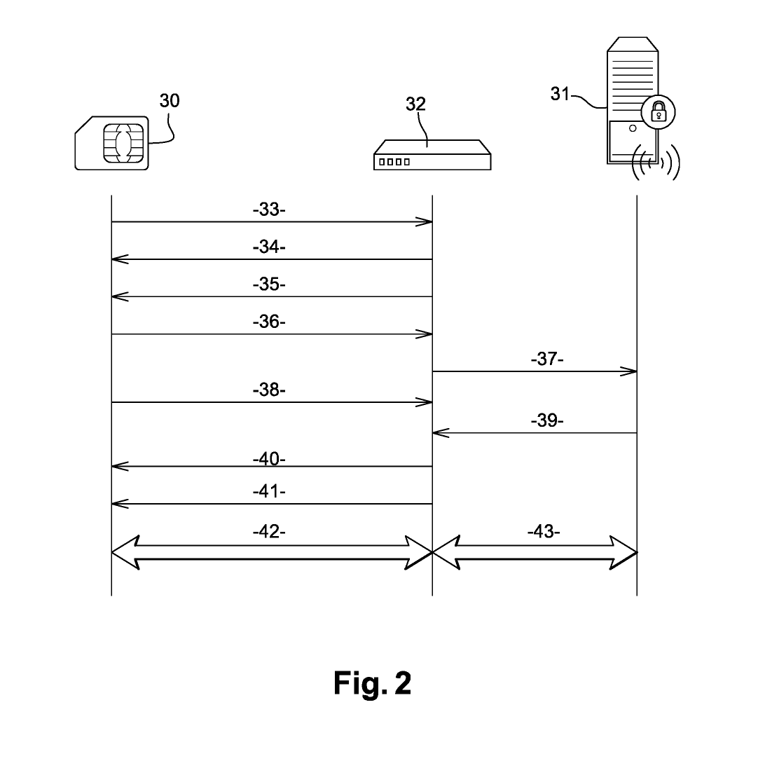

FIG. 2 illustrates a first embodiment of the invention;

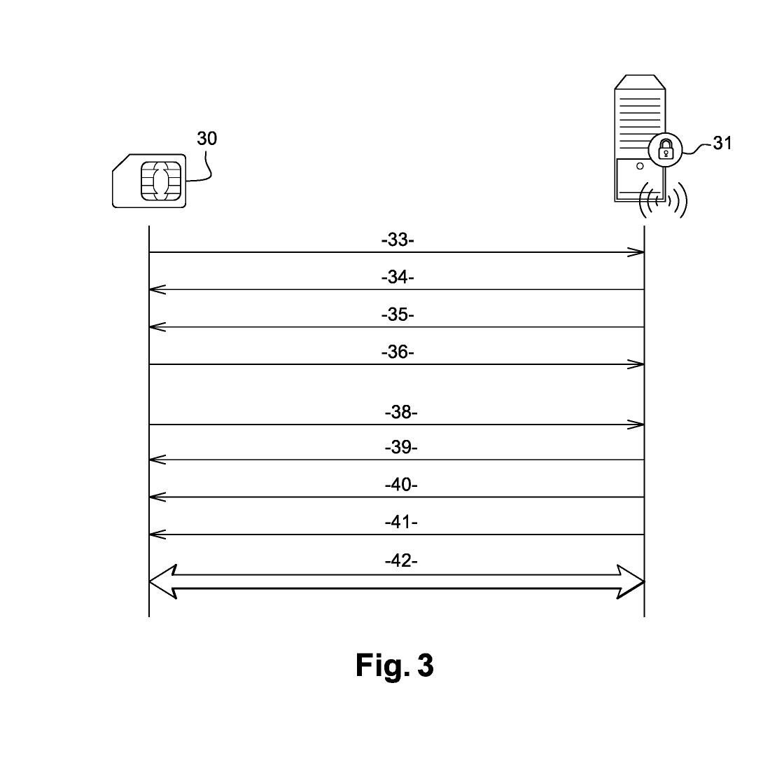

FIG. 3 illustrates a second embodiment of the invention;

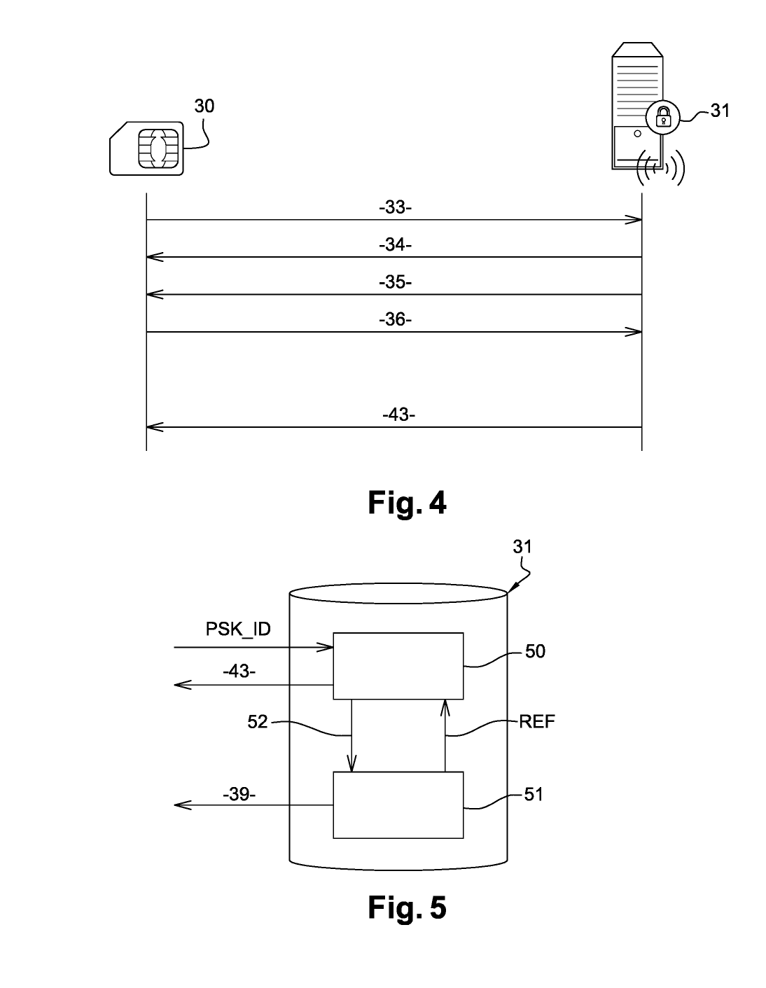

FIG. 4 shows how the present invention functions in the event that a request for administration of the security element is rejected;

FIG. 5 illustrates an OTA platform according to the present invention. FIG. 1 has been described above with reference to the state of the art. FIG. 2 illustrates a first embodiment of the invention.

In this first embodiment, a security element 30 queries an OTA platform 31 via a proxy server 32 to ask the OTA platform whether it has any data to transmit to the security element. The term “data” here is meant in the broadest sense and may involve transmission of a program, subscription data (IMSI/Ki for a new subscription with security domains and the corresponding keys) or simple updates of data or programs.

Stages 33 to 36 are similar to stages 12 to 15 in FIG. 1, i.e.:
The security element 30 contacts the proxy server (stage 33);
The proxy server 32 answers (stage 34);
The proxy server 32 confirms its answer (stage 35);
The security element 30 sends a PSK ID to the proxy server 32 (stage 36).

The particularity of stage 36 is that the identity (ID) of the PSK key shared between the security element 30 and the OTA platform 31 defines an order of priority for requesting that account be taken of its request by said OTA platform 31.

For each PSK key of a security element, several IDs are provided, each corresponding to an order of priority.

By way of an example, if a PSK key of a security element is 12345, multiple identities are allocated to this same key. The following PSK IDs for example will therefore be obtained:
12345-1
12345-2
12345-3
12345-N

Where 1 is the ID with the highest priority and N is the ID with the lowest priority. Priority implies an identity (ID) that requests the OTA platform 31 to process the request originating from the security element 30 as a priority over larger order IDs:

An identity (ID) with a 1st order priority may for example be related to a request of the security element to be initialised with operator parameters for a subscription membership. The operator, via his/her OTA platform 31, subsequently processes this request as a priority (as will be seen later), since it is of particular importance for the subscriber.

A 2nd order identity (ID) may for example correspond to a telephone directory download request from the subscriber. This operation is less crucial than the operation mentioned above.

A 3rd order identity (ID) may correspond to a download request for a list of preferred networks to which the security element 30 will preferably connect when roaming.

The IDs are preferably modifiable OTA in the security element 30. It is therefore possible to modify the orders of priority, as well as add and delete IDs.

The function of the proxy server 32 is to perform pre-filtering of the requests originating from the security elements. It can be configured to reject systematically requests originating from security elements having IDs above a given value. For this purpose, it is aware of the load status of the OTA platform 31 and filters the requests from the security elements accordingly. If it does not know the platform load status, it can simulate the latter by maintaining statistics concerning its use. If a request from a security element is of sufficiently high priority (defined by its ID), the proxy server, during a stage 37, transmits the PSK ID received during the stage 36 to the OTA server 31.

The proxy server 32 therefore filters the requests of the security elements based on the identities (IDs) before forwarding them to the OTA platform 31 if the identities (IDs) have an order of priority higher than a value stored in the proxy server 32. The proxy server 32 therefore makes it possible to avoid unnecessary data traffic originating essentially from establishment of TLS-PSK sessions between the security elements that “poll” the OTA platform 31.

During a stage 38, the security element 30 selects a cipher suite, for example an AES 128 or 3DES suite. This stage may also precede the stage 37.

If the OTA platform 31 accepts (depending on its load level and the priority assigned to the request of the security element) to carry out the request formulated by the security element 30, the platform sends, during a stage 39, session keys to the proxy server 32 which forwards the latter, during a stage 40, to the security element 30.

At the stage 41, the proxy server 32 finalises the stage of establishing a TLS-PSK session with the security element, which is subsequently able to dialogue, via the proxy server 32, with the OTA server 31 (stages 42 and 43). The proxy server 32 then only acts as a proxy (intermediate). During these stages (42 and 43), the security element 30 transmits the URL corresponding to its request (and likewise during the stage 19 in FIG. 1).

Alternatively, after the stage 33, the proxy server 32 can query the OTA server 31 to see if it is busy. The OTA server tells the proxy server if this is the case. The proxy server 32 then waits a few moments before repeating its request, until the OTA server tells the latter that it is available. The proxy server 32 subsequently informs the security element, during the stage 35, that it is prepared to fulfil its request (provided that the PSK ID that will be transmitted to it during the stage 36 is accepted by the proxy server 32 and the OTA platform 31).

FIG. 3 illustrates a second embodiment of the invention.

In this embodiment, the security element accesses the OTA platform directly, without any intermediate proxy server.

The security element 30 dialogues with the OTA platform 31 according to the stages referenced in FIG. 2 to which reference will be made. After having received the PSK ID of the security element 30 during the stage 36, means of filtering included in the OTA platform, which will be described below, analyse the identity (ID) of the request and only accept this request if the identity (ID) is below a reference value so that the latter can administer the security element 30 from which it originates.

Thus, if for example the identity (ID) transmitted to the platform 31 is equal to 2 and the reference value is equal to 3, the request for administration of the security element will be accepted and the platform 31 will send session keys to the security element during the stage 39. Conversely, if the identity (ID) transmitted to the platform 31 is equal to 4 and the reference value is equal to 3, the request for administration of the security element will be rejected (filtered by the means of filtering and not transmitted to the elements of the platform, the function of which is to administer the security element 30).

FIG. 4 shows the case in which a request for administration of the security element is rejected.

In this figure, stages 33 to 36 are identical to those in FIGS. 2 and 3.

On receiving the identity (ID) at the stage 36, the means of filtering consider that the means of administration of the security elements of the OTA platform cannot administer the security element 30 and return a message to this security element, during a stage 43, indicating that administration has failed. The security element 30 will subsequently await a future “polling” session to query the OTA platform 31 (stage 33).

FIG. 5 illustrates an OTA platform consistent with the present invention.

The OTA platform 31 according to the invention comprises means of filtering 50 and means of administration 51 of the security elements. The means of filtering receive in particular the PSK IDs of the security elements, extract the identities (IDs) from the latter and check whether the identities received are below (or above depending on the case) a reference value REF. The reference value REF is for example provided by the means of administration 51 to the means of filtering 50 depending on their load status (its activity).

The reference value REF can be advantageously modified during administration of the OTA platform or the proxy, for example, in order to reduce this reference value during peak traffic periods (sales periods for example) and increase it during periods of lower traffic level (at night for example).

The means of filtering 50 only transmit to the means of administration 51 of the security elements the requests, the identities (IDs) of which are below the reference value so that these means of administration 51 can manage the security elements from which they originate. They therefore function as a “firewall”.

In this respect, if an identity (ID) received by the means of filtering 30 is below the reference value REF, the request will be accepted by the means of filtering 50 which will transmit, during a stage 52, the PSK ID received to the means of administration 51 so that the latter can send, during the stage 39, session keys to the security element from which this PSK ID originates. Otherwise, the means of filtering 50 send the security element the message indicating that administration has failed (refer to stage 43 in FIG. 4).

The means of filtering therefore include a simple comparator of the identity (ID) received with the reference value REF.

The invention also relates to a security element, such as a SIM, UICC or eUICC card, allowing generation of different IDs according to one's own needs and/or those of one's user.

The needs of an UICC can be detected, for example, when its holder inserts it for the first time in a terminal and it does not contain a definitive subscription (it only contains a so-called “bootstrap” application allowing it to connect to an operator network or a dedicated platform capable of providing it with a complete subscription to an operator). Detection of the fact that the security element is abroad can also generate an automatic request for a list of preferred networks.

These different IDs are stored in the security element and each ID defines an order of priority for its request to be taken into account by a remote platform, this remote platform being for example an OTA platform (FIG. 3) or a proxy (FIG. 2) placed between the security element and the OTA platform.

1. Method for updating security elements interacting with telecommunications terminals, wherein said updates are carried out by an OTA platform based on requests made by said security elements, said security elements transmit PSK IDs to said OTA platform and said PSK IDs comprise identities,
wherein said identities define an order of priority of requests formulated by said security elements to said OTA platform.

2. Method according to claim 1, wherein the method involves transmitting said PSK IDs to said OTA platform via a proxy server.

3. Method according to claim 2, wherein said proxy server filters said requests based on said identities before forwarding them to said OTA platform if the identities have a higher order of priority than a value stored in said proxy server.

4. Method according to claim 1, wherein said identities can be modified OTA, in order to modify said orders of priority as well as add and delete IDs.

5. Security element interacting with a telecommunications terminal, wherein said security element is arranged to transmit a PSK ID to a remote platform in order to establish a secure channel between said security element and said remote platform, wherein the identity of said PSK ID defines an order of priority for requesting that account be taken of a request formulated by said security element to said remote platform.

6. Security element according to claim 5, wherein said remote platform is an OTA platform.

7. Security element according to claim 5, wherein said remote platform is a proxy placed between said security element and an OTA platform.

8. OTA platform designed to administer security elements interacting with terminals, wherein said security elements transmit update requests to said OTA platform, said OTA platform comprising means of administration of said security elements, wherein the OTA platform comprises means of filtering said requests, said requests comprising PSK IDs, the identities of which define an order of priority for requesting that account be taken of their requests by said OTA platform, the means of filtering transmitting to said means of administration of said security elements only those requests, the identities of which are below a reference value so that said means of administration can manage the security elements from which they originate.
